(19) United States
(12) Patent Application Publication
(10) Pub. No.: US 2020/0247422 A1
(43) Pub. Date: Aug. 6, 2020

(54) INATTENTIVE DRIVING SUPPRESSION SYSTEM

(71) Applicant: DENSO CORPORATION, Kariya-city (JP)

(72) Inventors: Ichiro YOSHIDA, Kariya-city (JP); Megumi NISHIGUCHI, Kariya-city (JP)

(21) Appl. No.: 16/853,453

(22) Filed: Apr. 20, 2020

Related U.S. Application Data
(63) Continuation of application No. PCT/JP2018/029600, filed on Aug. 7, 2018.

(30) Foreign Application Priority Data
Nov. 1, 2017 (JP) 2017-211745

(51) Int. Cl. B60W 40/09; B60W 50/16; G06K 9/00

(52) U.S. Cl. CPC B60W 40/09; B60W 2040/0818; G06K 9/00845; B60W 50/16

(57) ABSTRACT

A system for a vehicle is provided with a controller and detecting devices detecting information on driver state and/or vehicle state. The controller determines whether driver information matches a notification condition for transmitting the driver information to a communication terminal provided to a watcher via a communication network. The driver information includes information acquired from any one of the devices. In response to the driver information matching the notification condition, the driver information is transmitted to the communication terminal, and a stimulus is provided to the driver with a stimulus provision device according to an operation by the watcher via the communication terminal.

### CROSS-REFERENCE TO RELATED APPLICATION

The present application is a continuation application of International Patent Application No. PCT/JP2018/029600 filed on Aug. 7, 2018, which designated the U.S. and claims the benefit of priority from Japanese Patent Application No. 2017-211745 filed on Nov. 1, 2017. The entire disclosures of all of the above applications are incorporated herein by reference.

### TECHNICAL FIELD

The present disclosure relates to an inattentive driving suppression system for suppressing inattentive driving by a driver in a vehicle.

### BACKGROUND

There is an apparatus that sounds a warning to a driver in a vehicle to encourage safe driving if the driver is in a predetermined state such as closing their eyes for a predetermined period of time or failing to face the front. Such driver's state is determined by analyzing the direction of the face and/or the degree of opening of the eyes by using images acquired by a DSM (Driver Status Monitor), a drive recorder, etc.

### SUMMARY

According to an example of the present disclosure, a system for a vehicle may be provided with a controller and detecting devices detecting information on driver state and/or vehicle state. The controller may determine whether driver information matches a notification condition for transmitting the driver information to a communication terminal provided to a watcher via a communication network. The driver information may include information acquired from any one of the detecting devices. In response to the driver information matching the notification condition, the driver information may be transmitted to the communication terminal, and a stimulus may be provided to the driver with a stimulus provision device according to an operation by the watcher via the communication terminal.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram showing a schematic configuration of an inattentive driving suppression system according to an embodiment;

FIG. 2 is a flowchart showing an outline of setting a notification condition;

FIG. 3 is a flowchart showing an outline of operation control by the inattentive driving suppression system;

FIG. 4 is a sequence diagram showing the content of a stimulus providing process for a driver by a watcher;

FIG. 5 is a diagram schematically showing a display example in a display;

FIG. 6 is a diagram schematically showing a display example in a display;

FIG. 7 is a diagram schematically showing a display example in a display;

FIG. 8 is a diagram schematically showing a display example in a communication terminal;

FIG. 9 is a diagram schematically showing a display example in a communication terminal;

FIG. 10 is a diagram schematically showing a display example in a display;

FIG. 11 is a diagram schematically showing a display example in a communication terminal;

FIG. 12 is a diagram schematically showing a display example in a communication terminal; and

FIG. 13 is a diagram schematically showing a display example in a communication terminal.

### DETAILED DESCRIPTION

Hereinafter, embodiments will be described with reference to the drawings. In the following embodiment, common or related elements or substantially the same elements are denoted by the same reference signs, and description thereof will be omitted.

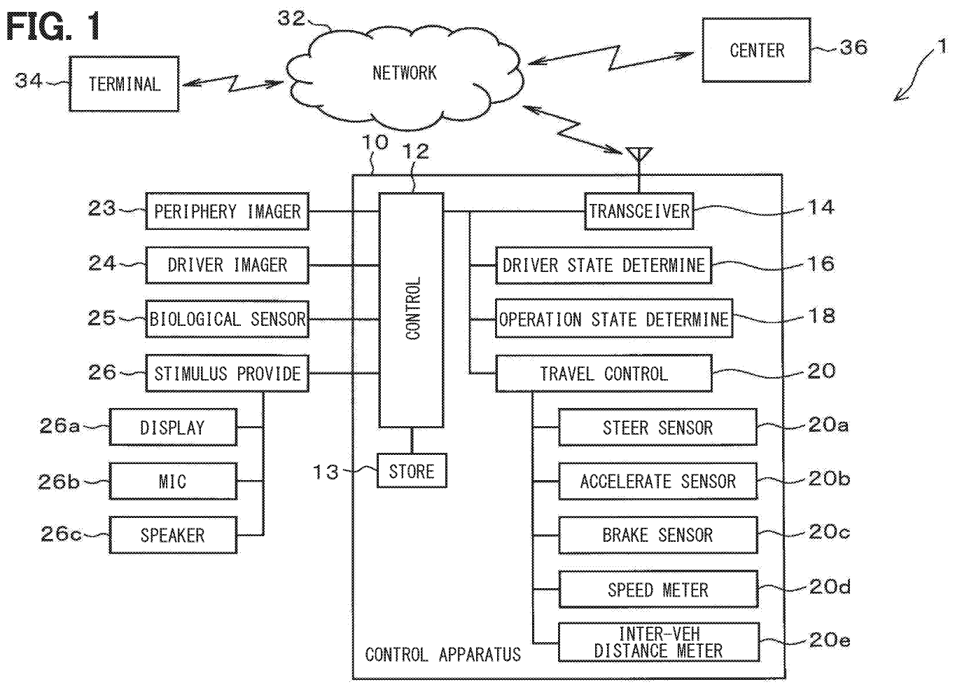

An embodiment will be described with reference to FIGS. 1 to 13. As shown in FIG. 1, an inattentive driving suppression system 1 includes a periphery imager device 23 (which also be referred to as a periphery imager), a driver imager device 24 (which also be referred to as a driver imager), a biological sensor 25, a stimulus provision device 26, and a control apparatus 10, which may also be referred to as a control circuit, connected with the foregoing devices and sensor via communication links. In addition, the inattentive driving suppression system 1 includes a communication terminal 34 connected by a communication network 32 such as the Internet. The inattentive driving suppression system 1 is used by being applied to a vehicle (not shown).

The control apparatus 10 includes a transceiver device 14 (which also be referred to as a transceiver), a driver state determination controller device 16 (which also be referred to as a driver state determination controller), an operation state determination controller device 18 (which also be referred to as an operation state determination controller), and a travel controller device 20 (which also be referred to as a travel controller), and a controller device 12 (which also be referred to as a controller) connected with the foregoing devices via communication links. Herein, the periphery imager device 23, the driver imager device 24, the biological sensor 25, and the travel controller device 20 may be referred to as detecting devices that detect information on driver state and/or vehicle state.

Further, the controller device 12 performs controls for the respective constituent elements in the inattentive driving suppression system 1 such as the transceiver device 14, the driver state determination controller device 16, the operation state determination controller device 18, the travel controller device 20, the periphery imager device 23, the driver imager device 24, the biological sensor 25, and the stimulus provision device 26. Note that, the “controller”, which may also serve as a processor, such as the driver state determination controller device 16, the operation state determination controller device 18, the travel controller device 20, the controller device 12, may be configured by (i) a central processing unit (CPU) along with memory storing instructions (i.e., computer program) executed by the CPU, or (ii) hardware circuitry such as an integrated circuit or hard-wired logic circuit with no CPU, or (iii) both the CPU along with memory and the hardware circuitry.

Further, those “controllers” may be combined as needed; namely, the control apparatus 10 may achieve the same functions by including one or more controllers or one or more processors.

As one example of the present embodiment, the controller device 12 mainly includes a microcomputer (not shown) having a CPU, a storage such as a ROM and a RAM, and an I/O, which are not shown. The controller device 12 executes a computer program stored in the ROM to perform the controls.

The communication terminal 34, which is a communication device that can be connected to the control apparatus 10 by communication, can employ terminals or devices such as a smartphone, a mobile personal computer.

The travel controller device 20 is communicably connected to a steering sensor 20a, an accelerator sensor 20b, a brake sensor 20c, a speed meter device 20d, and an inter-vehicle distance meter device 20e, via communication links. The steering sensor 20a is a sensor that detects a steering angle of the steering. The steering angle information of the steering is acquired by the travel controller device 20, which transmits the acquired information to the controller device 12 and the operation state determination controller device 18. The accelerator sensor 20b is a sensor that detects an amount of depression of the accelerator pedal. The depression amount information is acquired by the travel controller device 20, which transmits the acquired information to the controller device 12 and the operation state determination controller device 18.

The brake sensor 20c is a sensor that detects an amount of depression of the brake pedal. The travel controller device 20 acquires the brake depression amount information and transmits the acquired information to the controller device 12 and the operation state determination controller device 18. The speed meter device 20d is a vehicle speed sensor that detects a traveling speed of the vehicle. The vehicle speed acquired by the speed meter device 20d is acquired by the travel controller device 20, which transmits the acquired vehicle speed to the controller device 12 and the operation state determination controller device 18.

The inter-vehicle distance meter device 20e is a device that meters or measures an inter-vehicle distance between the host vehicle and another vehicle that runs in front or behind of the host vehicle. The inter-vehicle distance meter device 20e can employ a millimeter-wave radar type inter-vehicle distance measurement method with related circuitry, for instance. The inter-vehicle distance acquired by the inter-vehicle distance meter device 20e is acquired by the travel controller device 20, which transmits the acquired inter-vehicle distance to the controller device 12 and the operation state determination controller device 18.

The above-described information may be used by the operation state determination controller device 18 to determine whether the driving operation state of the vehicle operated by the driver matches a condition of a notification (hereinafter, referred to as a notification condition) set by a watcher. Here, the notification condition signifies a state in which an inattentive driving by the driver is suspected or a state in which an sign of an inattentive driving appears, from the driver state and/or the vehicle state. This notification condition is set by the watcher in the control apparatus 10 so as to transmit a notification to the watcher. The watcher, who has received this notification, grasps the driver's situation via the inattentive driving suppression system 1, determines whether the driver is driving inattentively, and provides a stimulus to the driver as needed.

The periphery imager device 23 is a camera that photographs or captures an image of an area peripheral to the vehicle, mainly, the surface of the road ahead as viewed from the vehicle. For example, the periphery imager device 23 may be provided by a photographing function of a drive recorder. The image captured or photographed by the periphery imager device 23 is analyzed by the controller device 12; thereby, the traveling state of the vehicle is grasped. The traveling state of the vehicle may be exemplified as a state where the vehicle deviates from a position on a road or a lane marking such as a lane center line, a lane boundary line, and a lane outside line. If an infrared camera is used as the periphery imager device 23, it is possible to acquire the traveling state of the vehicle even in a dark state without turning on the street lights and/or the headlights of the vehicle.

The driver imager device 24 is a camera that photographs or captures an image of the face, body, and the like of the driver of the vehicle. The image captured or photographed by the driver imager device 24 is subjected to image analysis by the controller device 12; thereby, the overall state of the driver, the state of the face, the degree of eye opening, the posture, the movement of the hands and the body, and the like are grasped. Further, if an infrared camera is used as the driver imager device 24, it is possible to acquire the driver's body temperature and the like. These pieces of image information are transmitted to the controller device 12.

If an omnidirectional imager is used as the imager device of the present embodiment, the periphery imager device 23 and the driver imager device 24 can be configured by a single imager device. The biological sensor 25 acquires biological information such as a driver's body temperature, pulse, blood pressure, and fingerprint. The driver's biological information is acquired by a contact type or non-contact type sensor or the like, and transmitted to the controller device 12. The driver's biological information can be acquired from a finger gripping the steering wheel by a temperature sensor, a pulse sensor, a blood pressure sensor, a fingerprint sensor, or the like (none shown) attached to the steering wheel. In addition, the face image, the fingerprint, the finger vein pattern, and the radial pattern of the iris can be obtained from the driver image captured by the driver imager device 24. The voiceprint can be obtained from the driver's utterance on the microphone 26b. In this case, the driver imager device 24 and the microphone 26b function as a biological sensor.

The stimulus provision device 26, which may also be referred to as an input and output interface device or an input and output interface, has a function of interfacing with the driver and guiding the driver to awaken by providing the stimulus to the driver. The stimulus provision device 26 includes, for example, a liquid crystal touch panel type display 26a and a microphone 26b in a car navigation device, and a speaker 26c of an audio instrument. The display 26a functions as an image display device; the speaker 26c functions as a sound generation device. The microphone 26b functions as a speech miking device that mikes an utterance by the driver, a sound in the vehicle, and the like. The provision of the stimulus to the driver includes displaying of characters and images on the display 26a, blinking of the whole of the display, conversation with a watcher using the microphone 26b and the speaker 26c, output of a warning sound using the speaker 26c, and the like.

The transceiver device 14 connects to the communication network 32 via wireless communication, to thereby connect to the communication terminal 34 via the communication network 32. Thus the transceiver device 14 has a function of transmitting and receiving data in the control apparatus 10 and data in the communication terminal 34. Thus, for example, the control apparatus 10 can transmit data to the communication terminal 34; the communication terminal 34 can operate the stimulus provision device 26 via the control apparatus 10.

The driver state determination controller device 16 analyzes the driver's image information acquired by the driver state imager device 24 and the driver's biological information acquired by the biological sensor 25, and thereby determines the driver's state.

The driver's image information acquired by the driver state imager device 24 and the driver's biological information acquired by the biological sensor 25 are analyzed to detect the number of times of yawns, the appearance, and the degree of eyelid opening, for example. The number of times of yawns, the appearance, and the degree of eyelid opening are factors or conditions related to the possibility of inattentive driving such as the driver falling asleep. Therefore, if the number of times of yawns, the appearance of the face, the degree of eyelid opening, and the like are set in a notification condition set by a watcher, which will be described later, it can contribute to avoidance of the driver's inattentive driving.

The operation state determination controller device 18 grasps the state of the vehicle operated by the driver based on the steering angle information from the steering sensor 20a, the accelerator depression amount information from the accelerator sensor 20b, and the brake depression amount information from the brake sensor 20c. For example, a high frequency in the vehicle running out of the lane markings, sudden steering, sudden braking, etc., is a factor or condition related to the possibility of the inattentive driving such as falling asleep, for example. Therefore, a high frequency in the vehicle running out of the lane markings, sudden steering, or sudden braking may be set in a notification condition set by a watcher, which will be described later. This can contribute to avoidance of a driver's inattentive driving.

The present embodiment provides a configuration in which the inattentive driving suppression system 1 (i.e., the control apparatus 10) recognizes the state of the driver or the vehicle. If the state of the driver or vehicle matches the notification condition set by the watcher, the watcher is notified of the driver information. The watcher thereby determines a driver's awakening state, and then provides a stimulus to the driver using the inattentive driving suppression system 1. Note that the watcher is a person whose information has been registered by the driver in advance such as biometric information that allows the driver to confirm the identity of the watcher (e.g., in a storage 13 in the control apparatus 10), in the inattentive driving suppression system 1. A configuration is employed in which only a watcher can access the inattentive driving suppression system 1 by receiving an access permission through the identity confirmation using the biological information or the like. Thus, a configuration is employed in which only the watcher can operate the stimulus provision device 26 via the control apparatus 10. That is, a configuration may be employed in which only the registered watcher having undergone the identity confirmation via the communication terminal 34 is enabled to access the inattentive driving suppression system 1 and operate the stimulus provision device 26.

Further, the present embodiment supposes that the watcher is a person who knows well how the driver's inattentive driving progresses. For example, the watcher may be, of the driver, a family member, an acquaintance, a colleague, who knows the driver well and understands the situation and/or habit of how the driver transitions to inattentive driving. In other words, the watcher is a person who is aware of the process in which the driver proceeds to the inattentive state. Such a watcher can recognize the signs of a driver's tiredness, lack of concentration, or mental instability. The inattentive driving suppression system 1 according to the present embodiment is configured by focusing on the above supposition.

The watcher is a person who has been registered in advance by the driver in the inattentive driving suppression system 1. The registration of the watcher is performed by an application (hereinafter, referred to as an application A) installed in the control apparatus 10 in advance. The name, nickname, face photograph, and access information to the communication terminal 34 of the watcher are registered.

An application (hereinafter, referred to as an application B) which can cooperate with the application A is installed in the communication terminal 34 provided to the watcher. The watcher operates the application B to access the inattentive driving suppression system 1. A configuration is employed in which a person who can access the inattentive driving suppression system 1 by cooperation between the application A and the application B is limited to a watcher registered in advance by the driver. This is achieved by the driver limiting a person who is registered with the inattentive driving suppression system 1.

A configuration may be employed in which in registration of a watcher, the application A is able to cooperate with a mobile terminal held by the driver; the registration of the watcher may be performed using an address book or the like stored in the mobile terminal held by the driver. In addition, mutually different access rights may be given to a plurality of watchers to limit operations that can be performed using the inattentive driving suppression system 1. When the registration is completed, a notification indicating that the registration has been completed is transmitted from the inattentive driving suppression system 1 to the corresponding watcher.

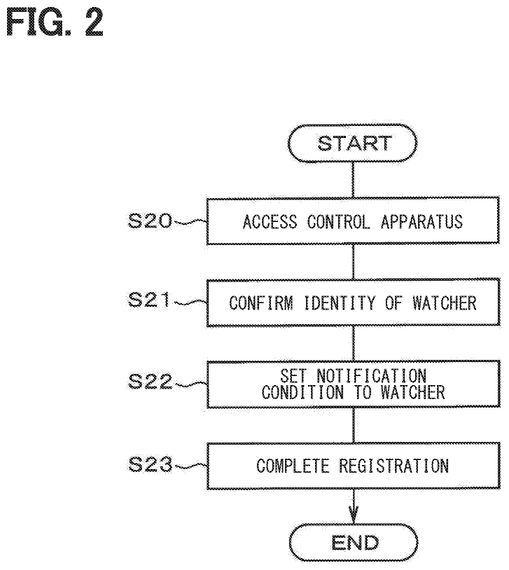

As shown in FIG. 2, the watcher who has received the notification first accesses the control apparatus 10 in the inattentive driving suppression system 1 (step S20). Next, the control apparatus 10 determines whether the registered information of the watcher registered in advance by the driver matches the information of the watcher currently accessing the control apparatus 10, thereby performing the identity confirmation as to whether the watcher is registered (step S21). In step S21, the identity confirmation of the watcher is performed by comparing the biological information stored in the control apparatus 10 in advance with the biological information transmitted from the communication terminal 34 to the control apparatus 10. For example, the biological information may include a plurality of information items or characteristics such as a face image, fingerprint, finger vein pattern, radial pattern of an iris, and voiceprint of the watcher.

The identity confirmation may be performed by selecting any one of a plurality of information items or characteristics of the biometric information, and may be performed using several or all of the plurality of information items or characteristics of the biometric information. Here, for example, the face authentication may be performed using a face image of a watcher acquired with a camera function built in the communication terminal 34. In addition, the voiceprint authentication may be performed using a voiceprint acquired by the utterance. The identity of the watcher can be thus confirmed or verified. When the identity of the watcher who accesses the inattentive driving suppression system 1 is successfully confirmed, the watcher registers a condition under which the control apparatus 10 notifies the watcher (step S22). The registration conditions here include, for example, the following items or conditions.
Opening degree of the driver's eyelids: For example, the degree of opening of the driver's eyes is measured by a camera installed in the vehicle. The condition where the degree of opening less than 30% is 55% or more per minute is set as a registration condition.
Pupil movement: The driver's eyes are photographed by a camera installed in the vehicle. The opening of the pupils and the movement of the line of sight are tracked. The condition where a difference in the pupil opening is only within ±10% in a certain period of time (e.g., within one minute), or the condition where the movement of the line of sight is within a certain range (e.g., within a radius of 10 cm) is set as a registration condition.
The number of blinks of the driver: For example, the frequency of blinks decreases or increases when the driver becomes sleepy. The predetermined number of blinks is set as a notification condition.
Driver's line of sight: The camera installed in the vehicle photographs the driver's eyes and tracks the line of sight. This information and vehicle route information from a car navigation system are used. The condition where the driver's line of sight turns 65% or more within a certain time (e.g., within one minute) in a direction other than the traveling direction of the vehicle is set as a notification condition.
Driver appearance: The driver is photographed by a camera installed in the vehicle. The following conditions continuing for a predetermined period of time (for example, 30 seconds) are individually set as a notification condition. The condition is that the driver cannot be photographed. The condition is that the driver disappears from the screen. The condition is that the driver faces down. The condition is that there is no iris part of the eyes (that is, the state of white eyes).
The presence or absence of an action of providing a stimulus to the driver himself or herself: For example, when the driver becomes sleepy, the driver performs an action of stimulating himself/herself, such as rubbing their eyes to awaken himself or herself. Such a condition is set as a notification condition.
The number of yawns: For example, when sleepy, the frequency of yawns is increased. A predetermined number of yawns is set as a notification condition.
Neglecting signals or road signs such as “stop”: Temporary stop information is acquired from map information such as in a car navigation system. The periphery imager device 23 photographs traffic signals and/or signs ahead of the vehicle. The above information is used to determine a dangerous action. The condition where such a dangerous action is determined is set as a notification condition.
State of the vehicle deviating from a lane marking such as a lane center line, a lane boundary line, and a lane outside line: The image captured by the periphery imager device 23 is analyzed. A predetermined frequency of the vehicle deviating from the lane markings is set as a notification condition.
Operation information from the steering sensor 20a, the accelerator sensor 20b, and the brake sensor 20c: The condition where these operations cannot be detected for a predetermined period of time is set as a notification condition.
Hand or body posture: The condition where there is a sign that the vehicle will shift to inattentive driving is set as a notification condition. For instance, the driver has a habit of touching the chin with their hand when he or she becomes sleepy. Such an action being determined is set as a notification condition.
Sudden brake detection: The condition where a sudden brake is detected based on information on the amount of depression of the brake from the brake sensor 20c is set as a notification condition.

Note that the above notification conditions are examples, and are not limited thereto. For instance, a notification condition may be: the condition where a state in which the inter-vehicle distance acquired by the inter-vehicle distance meter device 20e is shorter than a predetermined distance continues for a predetermined period of time or more; the condition where the vehicle speed acquired by the speed meter device 20d is in excess of the legal speed or in a state of being equal to or less than the predetermined speed continues for a predetermined time or more; or the condition where the blood pressure value, pulse, or body temperature value obtained by the biological sensor 25 deviates from a predetermined range.

These actions are grasped by the control apparatus 10 analyzing the image of the driver acquired by the driver imager device 24. A predetermined condition of the above actions is set as a notification condition set by a watcher. Thus, the registration of the notification condition is completed (step S23). These condition settings may be stored in the storage 13 in the control apparatus 10, for instance. There may be a plurality of watchers. In such cases, the plurality of watches may set the respective conditions in which the control apparatus 10 notifies the corresponding watchers. Thus the different conditions may be set by the respective watchers.

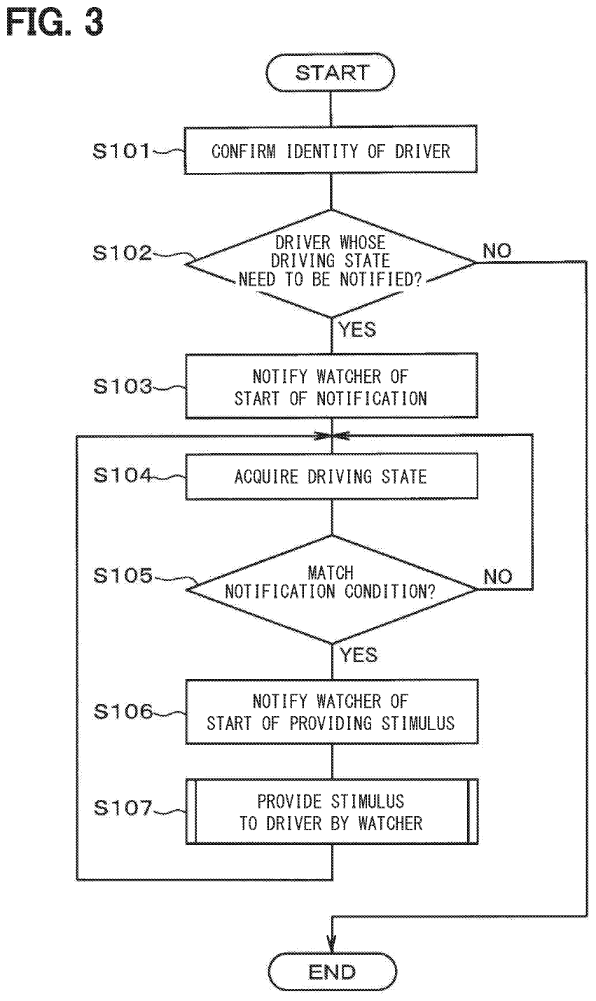

The inattentive driving suppression system 1 operates as follows. As shown in FIG. 3, first, after the driver gets on the vehicle, the driver starts the vehicle. The inattentive driving suppression system 1 is activated; the process of confirming the identity of the driver is performed (step S101).

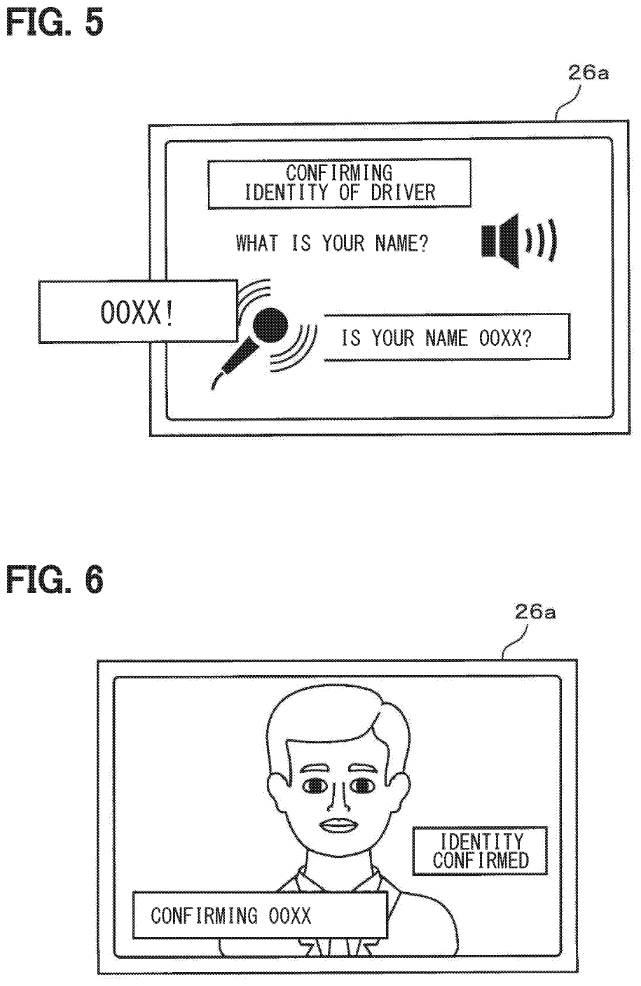

The identity conformation of the driver is performed by the authentication through comparing the personal characteristic information of the driver previously registered in the control apparatus 10 with the corresponding biometric information acquired from the driver (step S101). The personal characteristic information includes a driver's face image, voiceprint, and fingerprint registered in advance in the control apparatus 10. The biometric information includes the occupant's face image acquired by the driver imager device 24, the driver's voiceprint acquired by the microphone 26b, and the fingerprint acquired from the driver's finger. Then, whether the occupant is a registered driver (i.e., a driver whose driving status needs to be notified of) is determined by comparing the personal characteristic information with the biometric information (step S102). For example, as shown in FIG. 5, the voiceprint of the driver is collected by prompting the driver to utter the voiceprint, and the voiceprint is authenticated. The identity is thereby confirmed as shown in FIG. 6.

When the occupant is not the driver registered as a driver whose driving status needs to be notified of (step S102: NO), the control apparatus 10 ends the process. When the occupant is a driver registered as a driver whose driving status needs to be notified (step S102: YES), the control apparatus 10 shifts to a mode of “driver's driving status needs to be notified”. The watcher is notified that the notification of the driver's status has started (step S103). Thereafter, the control apparatus 10 starts acquiring of driver status information (step S104) and starts determining of whether the driver status information matches the notification condition (step S105).

When the driving status of the driver matches the notification condition (step S105: YES), the control apparatus 10 notifies the watcher that the process of providing the driver with the stimulus is started (step S106).

When the driving status of the driver does not match the notification condition (step S105: NO), the control apparatus 10 returns to step S104 and continues to acquire the driver's status information. As a result of the determination again, when the driver's status matches the notification condition (step S105: YES), the watcher is notified that the process of providing the driver with the stimulus is started (step S106).

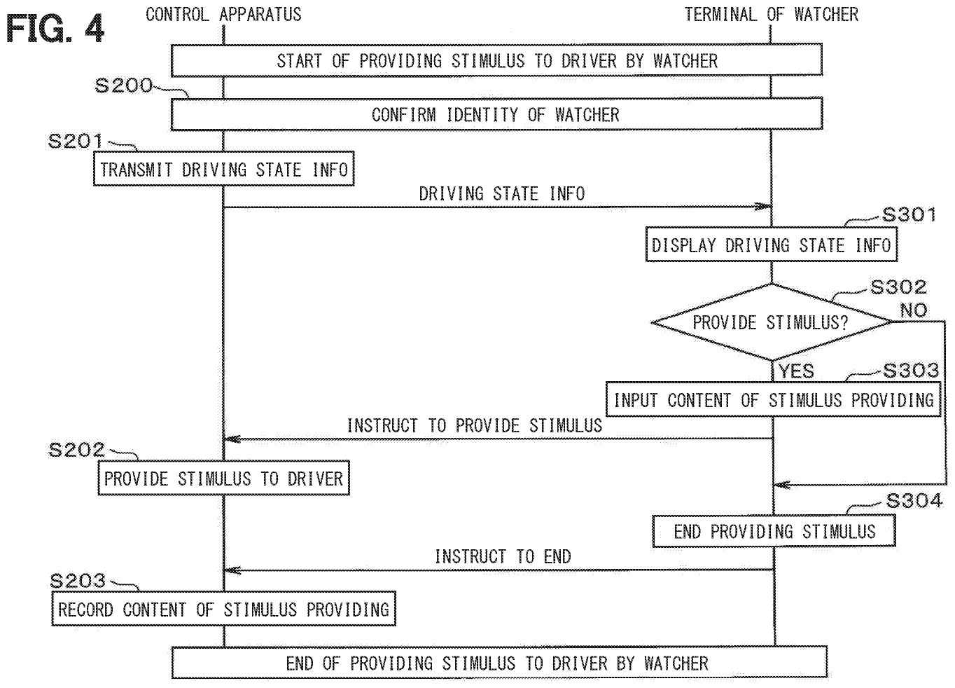

Next, the control apparatus 10 performs a stimulus providing process for the driver by the watcher (step S107). The content of the stimulus providing process for the driver by the watcher will be described later with reference to FIG. 4.

Next, when the stimulus providing process for the driver by the watcher is completed, the process proceeds to the acquisition of the driving status in step S104. Again, the determination as to whether the driver status information matches the notification condition is continued (step S105). As a result of the determination again, when the driver status matches the notification condition (step S105: YES), the watcher is notified that the stimulus providing process for the driver is started (step S106). The stimulus providing process for the driver is performed by the watcher (step S107). FIG. 8 shows a display example on the communication terminal 34 in this case. On the other hand, as shown in FIG. 8, in consideration of the convenience of the watcher, the watcher may be able to select “OK” or “decline”.

As described above, steps S104 to S107 are repeatedly executed until the driving of the vehicle by the driver ends. Next, the contents of the stimulus providing process for the driver (step S107) by the watcher will be described.

As shown in FIG. 4, when the process of providing a stimulus to a driver by a watcher is started, the control apparatus 10 shifts to a mode for transmitting driver status information (step S201). First, the identity confirmation of the watcher is performed (step S200). The identity confirmation of the watcher is performed by comparing the information of the watcher stored in the control apparatus 10 with the information of the watcher transmitted from the communication terminal 34 in the identity conformation of the watcher. For example, the information of the watcher (i.e., personal characteristic) includes a face image, a fingerprint, a finger vein pattern, a radial pattern of an iris, and a voiceprint.

In step S200, when the identity confirmation of the watcher is unsuccessful, the stimulus providing process to the driver by the present watcher (step S107) ends. When there are a plurality of watchers, the communication terminal 34 of the watcher whose identity confirmation has succeeded receives the driving status information of the driver as described below. The following describes the sequence for a watcher whose identity has been successfully confirmed.

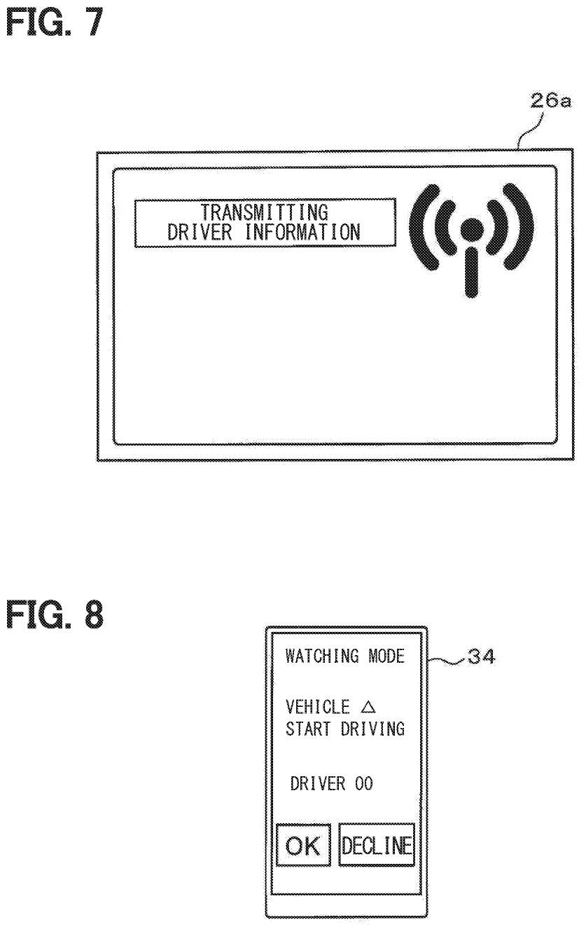

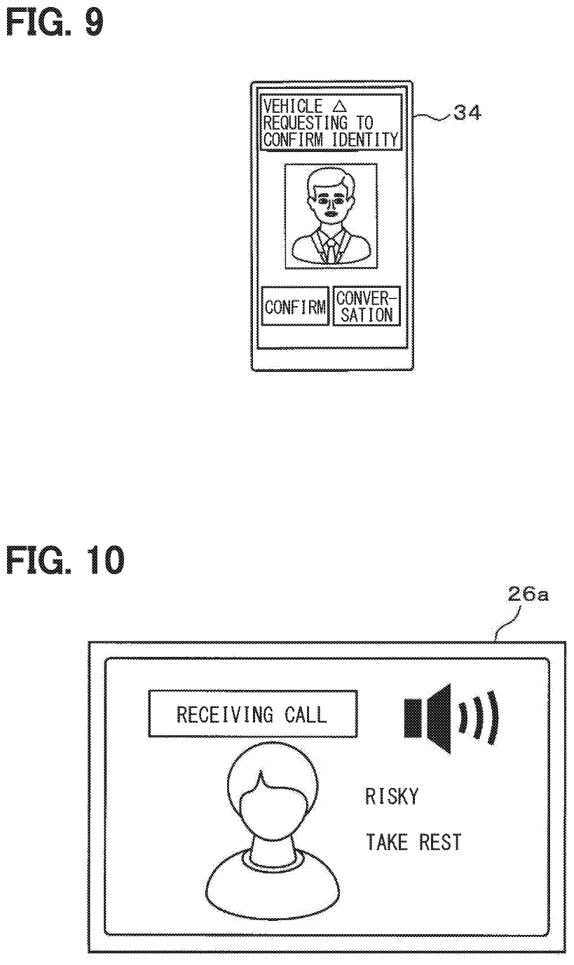

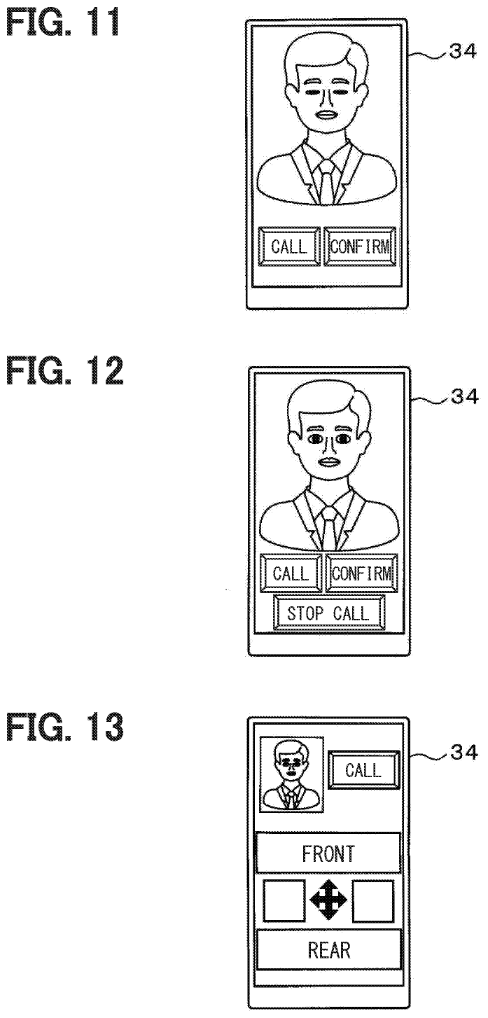

In step S200, when the identity confirmation of the watcher succeeds, the driving status information of the driver is transmitted to the communication terminal 34 of the watcher. This display example is shown in FIG. 9. In response to this, the display 26a in the control apparatus 10 displays that the driving status information of the driver is in a transmission state, for example, as shown in FIG. 7, and the communication terminal 34 displays the driver status as shown in FIG. 11 (step S301). In transmitting the driver's driving status information, for example, the captured image of the driver may be continuously transmitted by streaming.

The watcher who has confirmed the driving status information of the driver displayed on the communication terminal 34 determines whether to provide a stimulus to the driver. When it is determined that the stimulus is to be provided, the stimulus is provided to the driver by operating the communication terminal 34 (step S302: YES).

Here, the communication terminal 34 is configured to be able to select one of stimulus providing techniques for the driver, and the technique or the content of the stimulus providing process is input (step S303). For instance, a configuration may be employed in which one of the followings is selected: the provision of a stimulus by a watcher's call to the driver via the microphone 26b and the speaker 26c of the stimulus provision device 26 in the control apparatus 10; the provision of a stimulus by uttering a warning via the speaker 26c; and the provision of a stimulus via display of warning message on display 26a. That is, the provision of the stimulus in the inattentive driving suppression system 1 is performed by providing a stimulus to the driver's hearing and vision, and a stimulus based on the self-utterance.

FIGS. 10, 11 and 12 show display examples of the stimulus provision device 26 and the communication terminal 34 in the case of providing a stimulus by a watcher's call to the driver. As shown in FIG. 11, the watcher presses the “call” button to execute the call. This corresponds to the input of the stimulus provision process in the communication terminal 34 (step S303). The stimulus provision instruction is transmitted to the control apparatus 10 by inputting the stimulus provision process in the communication terminal 34.

In response thereto, as shown in FIG. 10, the control apparatus 10 calls the driver using a calling voice pattern prepared in advance in the control apparatus 10, thereby executing a stimulus providing process for the driver (step S202).

Another configuration may be employed in which the line of the microphone 26b of the stimulus provision device 26 may be opened by inputting the stimulus providing process in the communication terminal 34, so that the watcher can call via the communication terminal 34. The call to the driver by the watcher corresponds to the output of providing the stimulus to the driver in the control apparatus 10 (step S202). The driver may respond to this through the microphone 26b of the stimulus provision device 26.

The response, that is, the utterance by the driver also stimulates the driver, and urges the driver to wake up. In this case, as shown in FIG. 13, a configuration may be employed in which an image from the front or rear of the vehicle, or the status of the front passenger seat or the rear seat can be confirmed by an operation from the communication terminal 34.

The watcher can confirm the driver's awakening by confirming the driver's response, and press the “calling stop” button as shown in FIG. 12 to end the stimulus providing process to the driver (Step S304). As a result, an instruction to end the stimulus providing process is issued to the control apparatus 10, and the control apparatus 10 records the content or technique of the stimulus providing process provided to the driver (step S203). The stimulus providing process ends.

Suppose a case where the inattentive driving suppression system 1 according to the embodiment is applied to business vehicles such as taxis and trucks. In such a case, a watcher is assumed to be a staff member in a vehicle management center 36 of a company managing these business vehicles, as shown in FIG. 1. In this case, the person in charge who is a watcher watches the driver via the communication terminal 34 in the management center. In this case, the registration of a watcher in the control apparatus 10 may be performed by the watcher who is a person in charge in the management center. When there are a plurality of business vehicles, a predetermined condition prepared in advance as a notification condition set by a watcher may be applied to all vehicles for operation.

In addition, suppose a case where the inattentive driving suppression system 1 according to the embodiment is applied to a one-time use vehicle such as a rental car. In such a case, a configuration may be employed in which the setting of the driver, the setting of the watcher, the setting of the notification condition, and the like may be all deleted when the vehicle is returned.

Further, the display 26a, the microphone 26b, and the speaker 26c are illustrated as the stimulus provision device 26 that provides the stimulus to the driver, but the stimulus provision device 26 is not limited thereto. For example, various techniques for providing stimulus may be employed as follows: installing a device that vibrates the seat where the driver sits and vibrating the device so as to provide stimulation to the driver; operating an air conditioner to perform cooling operation so as to provide stimulation to the driver; operating an audio instrument to play music at high volume; and installing a device that sprays perfume in the vehicle and operating the device to spray perfume so as to provide the driver with olfactory stimulation.

The above-described inattentive driving suppression system 1 can provide the effects as follows. The control apparatus 10 in the inattentive driving suppression system 1 determines whether the driving status of the driver acquired by the periphery imager device 23, the driver imager device 24, the biological sensor 25 matches the notification condition set by the watcher. In response to that it is determined that the driving status matches the notification condition, the driving status of the driver is transmitted to the watcher, and the stimulus providing process to the driver by the watcher is started. That is, if the watcher grasps the status of the driver and determines that it is necessary to provide stimulus to awaken the driver, the watcher operates the communication terminal 34 so that the stimulus provision device 26 included in the control apparatus 10 is remotely operated to provide the stimulus to the driver. This enables reliable avoidance of the driver's inattentive state.

Sending the driving status information of the driver to the watcher enables the watcher to reliably determine the driver's inattentive status. This can more reliably prevent the driver from driving inattentively, in particular, before the system of the vehicle has sufficiently learned about the driver's inattentive driving status.

In addition, a watcher may be set to a person who knows well how a driver drives in an inattentive manner, i.e., a person who is aware of the status or habit of how the driver transitions to an inattentive driving, such as a family member, an acquaintance, or a colleague. This can improve the accuracy of the determination of the driver's inattentive driving. This makes it possible to avoid the driver's inattentive state with higher accuracy and more reliably.

Further, this configuration can provide the stimulus to the driver by various stimulus providing techniques selected by the watcher. This can solve the issue that the driver is used to the warning notification many times by receiving the same warning notification and the driver becomes difficult to awaken. Therefore, it is possible to more reliably avoid the driver's inattentive state.

It should be understood that the present disclosure described based on the embodiment is not limited to the embodiment or structures presented herein. The present disclosure encompasses various modifications and variations within the scope of equivalents. In addition, various combinations and configurations, as well as other combinations and configurations that include only one element, more, or less, are within the scope and spirit of the present disclosure.

For reference to further explain features of the present disclosure, the description is added as follows.

For instance, a sleepiness prevention apparatus may be configured to notify a predetermined notification destination when determining that the driver is in a sleeping state or a strongly sleepy state.

The sleepiness prevention apparatus may need to take a certain period of time to learn the progress status of the driver's inattentive driving. During such a period of time for learning, it may be thus difficult to accurately determine the driver's inattentive state. This poses the issues. For instance, it may be difficult to prevent accidents before occurring. If the driver is informed of the same warning many times, the familiarity with the notification of the warning may reduce the effectiveness in awakening.

It is thus desired to provide an inattentive driving suppression system that can more reliably avoid a driver's inattentive state.

An aspect of the present disclosure described herein is set forth in the following clauses.

According to an aspect of the present disclosure, an inattentive driving suppression system may be provided to include (i) detecting devices detecting information on driver state and/or vehicle state, (ii) a control apparatus that controls the detecting devices, (iii) a stimulus provision device configured to provide a stimulus to the driver, and (iv) a communication terminal communicably connectable to the control apparatus via a communication network. The communication terminal may be provided to a watcher, who may be a person registered in advance by the driver. The detecting devices may be: a periphery imager device configured to capture an image of an area peripheral to the vehicle; a driver imager device configured to capture an image of the driver of the vehicle; a biological sensor configured to acquire biological information of the driver; and a travel controller device configured to control travel of the vehicle. Herein the control apparatus may be configured to determine whether driver information matches a predetermined notification condition. The driver information may include information acquired from any one of the detecting devices. The notification condition may be a condition for transmitting the driver information to the communication terminal provided to the watcher. In response to the driver information matching the predetermined notification condition, the control apparatus may be configured to transmit the driver information to the communication terminal, and provide a stimulus to the driver by using the stimulus provision device according to an operation by the watcher via the communication terminal.

According to this configuration, the watcher may grasp the state of the driver and determine the necessity to provide a stimulus to awaken the driver. In the case, the watcher may manipulate the communication terminal so as to operate remotely the stimulus provision device included in the control apparatus. The stimulus may be thereby provided to the driver, to reliably avoid the driver's inattentive state.

What is claimed is:

1. An inattentive driving suppression system comprising:
a periphery imager device configured to capture an image of an area peripheral to a vehicle;
a driver imager device configured to capture an image of a driver of the vehicle;
a biological sensor configured to acquire biological information of the driver;
a stimulus provision device configured to provide a stimulus to the driver;
a travel controller device configured to control travel of the vehicle;
a control apparatus configured to control the periphery imager device, the driver imager device, the biological sensor, the stimulus provision device, and the travel controller device; and
a communication terminal communicably connectable to the control apparatus via a communication network, the communication terminal being provided to a watcher, who is a person registered in advance by the driver,
wherein:
the control apparatus is configured to determine whether driver information matches a predetermined notification condition,
the driver information including information acquired from any one of the periphery imager device, the driver imager device, the biological sensor, and the travel controller device,
the notification condition being a condition for transmitting the driver information to the communication terminal provided to the watcher;
in response to the driver information matching the predetermined notification condition, the control apparatus is configured to transmit the driver information to the communication terminal, and provide a stimulus to the driver by using the stimulus provision device according to an operation by the watcher via the communication terminal;
information to confirm an identity of the watcher is registered by the driver in the inattentive driving suppression system, and an access to the control apparatus is permitted for the watcher in response to the identity of the watcher being successfully confirmed by using the information;
the watcher is aware of a progress by which the driver transitions to an inattentive state; and
the notification condition to the watcher is set by the watcher.

2. The inattentive driving suppression system according to claim 1, wherein:
only the watcher is enabled to connect to the control apparatus via the communication terminal; and
only the watcher is enabled to operate the stimulus provision device via the communication terminal.

3. The inattentive driving suppression system according to claim 1, wherein
the stimulus provided to the driver includes any one of a stimulus provided to an auditory sense, a stimulus provided to a visual sense, and a stimulus by self-utterance of the driver.

4. The inattentive driving suppression system according to claim 1, wherein:
the stimulus provision device includes a display, a microphone, and a speaker; and
the stimulus is provided to the driver by using the display, the microphone, and the speaker.

5. The inattentive driving suppression system according to claim 1, wherein
the information to confirm the identity of the watcher includes any one of a face image, a fingerprint, a finger vein pattern, a radial pattern of an iris, and a voiceprint.

6. The inattentive driving suppression system according to claim 1, wherein
the notification condition for transmitting the driver information to the communication terminal provided to the watcher includes any one of a degree of opening of eyelids, a movement of pupils, a counted number of blinks of the driver, a movement of a line of sight of the driver, an appearance of the driver, whether or not the driver provides stimulus to himself or herself, a counted number of yawning actions, a counted number of neglects of road signs and signals, and a counted number of deviations from lane markings.

7. An inattentive driving suppression system comprising:
a control apparatus including a controller;
a plurality of detecting devices communicably connected to the control apparatus via communication links and controlled by the controller, the detecting devices being configured to detect information on driver state, or vehicle state, or driver state and vehicle state;
an input and output interface communicably connected to the control apparatus via a communication link and controlled by the controller, the input and output interface being configured to interface with a driver of a vehicle to provide a stimulus to the driver;
a storage where information registered by the driver is stored to confirm an identity of a watcher, wherein an access to the control apparatus is permitted for the watcher in response to the identity of the watcher being successfully confirmed by using the information; and
a communication terminal communicably connectable to the control apparatus via a communication network, the communication terminal being provided to the watcher,
wherein:
the controller in the control apparatus is configured to determine whether driver information matches a predetermined notification condition set by the watcher,
the driver information including information acquired from any one of the detecting devices,
the notification condition being a condition for transmitting the driver information to the communication terminal provided to the watcher; and
in response to the driver information matching the predetermined notification condition, the controller in the control apparatus is configured to transmit the driver information to the communication terminal, and provide a stimulus to the driver by using the input and output interface according to an operation via the communication terminal by the watcher whose identity has been successfully confirmed.

8. The inattentive driving suppression system according to claim 7, wherein
the detecting devices include:
a biological sensor configured to acquire biological information of the driver;
a driver imager configured to capture an image of the driver of the vehicle;
a periphery imager configured to capture an image of an area peripheral to the vehicle; and
a travel controller configured to control travel of the vehicle.

9. The inattentive driving suppression system according to claim 7, wherein
the watcher is aware of a progress by which the driver transitions to an inattentive state.

10. The inattentive driving suppression system according to claim 7, wherein:
only the watcher is enabled to connect to the control apparatus via the communication terminal; and
only the watcher is enabled to operate the input and output interface via the communication terminal.

11. The inattentive driving suppression system according to claim 7, wherein
the stimulus provided to the driver includes any one stimulus selected from three stimuluses that are a first stimulus provided to an auditory sense, a second stimulus provided to a visual sense, and a third stimulus by self-utterance of the driver.

12. The inattentive driving suppression system according to claim 7, wherein:
the input and output interface includes three devices that are a first device being a display, a second device being a microphone, and a third device being a speaker; and
the stimulus is provided to the driver by using the three devices.

13. The inattentive driving suppression system according to claim 7, wherein
the information to confirm the identity of the watcher includes any one character selected from five characters that a first character being a face image, a second character being a fingerprint, a third character being a finger vein pattern, a fourth character being a radial pattern of an iris, and a fifth character being a voiceprint.

14. The inattentive driving suppression system according to claim 7, wherein
the notification condition for transmitting the driver information to the communication terminal includes any one condition selected from nine conditions that are a first condition being a degree of opening of eyelids, a second condition being a movement of pupils, a third condition being a counted number of blinks of the driver, a fourth condition being a movement of a line of sight of the driver, a fifth condition being an appearance of the driver, a sixth condition being whether or not the driver provides stimulus to himself or herself, a seventh condition being a counted number of yawning actions, an eighth condition being a counted number of neglects of road signs and signals, and a ninth condition being a counted number of deviations from lane markings.
